(19) United States
(12) Patent Application Publication
(10) Pub. No.: US 2016/0103070 A1
(43) Pub. Date: Apr. 14, 2016

(54) METHOD FOR MULTIPLE ANALYSIS OF RAMAN SPECTROSCOPY SIGNAL

(71) Applicant: SAMSUNG ELECTRONICS CO., LTD., Suwon-si (KR)

(72) Inventor: Jisoo KYOUNG, Seoul (KR)

(73) Assignee: SAMSUNG ELECTRONICS CO., LTD., Suwon-si (KR)

(21) Appl. No.: 14/694,666

(22) Filed: Apr. 23, 2015

(30) Foreign Application Priority Data
Oct. 8, 2014 (KR) 10-2014-0135957

(51) Int. Cl. G01N 21/65; G01N 21/88

(52) U.S. Cl. CPC G01N 21/65; G01N 21/8851

(57) ABSTRACT

A method for multiple analysis of a Raman spectroscopy signal includes repeating a process of obtaining a Raman signal with respect to a sample and a process of measuring a necessary factor with respect to the sample, with respect to a plurality of samples, extracting a plurality of parameters from the Raman signal obtained from each of the plurality of samples, and creating a multiple analysis algorithm such that a calculated property obtained by inputting the plurality of parameters obtained in the extracting of a plurality of parameters for each sample into the multiple analysis algorithm approximates the measured property, and in which a property of an object to be measured is anticipated by inputting a plurality of parameters extracted from a Raman signal with respect to the object to be measured into the learned multiple analysis algorithm.

### RELATED APPLICATION

This application claims priority from Korean Patent Application No. 10-2014-0135957, filed on Oct. 8, 2014, in the Korean Intellectual Property Office, the disclosure of which is incorporated herein in its entirety by reference.

### BACKGROUND

1. Field

Methods consistent with exemplary embodiments relate to multiple analysis of a Raman spectroscopy signal.

2. Description of the Related Art

Two-dimensional materials including graphene have many merits and are touted as useful new materials. In particular, graphene is being actively studied as as an electronic device material to possibly replace silicon. To use graphene as a material for electronic devices, information about the properties of graphene, such as a doping level, mobility, a degree of strain, a domain size, a defect distance, etc., is needed Also, before entering a mass production stage, these properties of graphene over a wafer are needed.

However, measuring these properties is not easy. For example, mobility and doping level are measurable by applying a gate voltage and measuring a one V curve. However, source, drain, and gate electrodes need to be formed by patterning the graphene, and a measuring method requiring applying a gate voltage corresponds to a destruction test. Accordingly, it is impossible to measure all devices including graphene using this above method.

### SUMMARY

One or more exemplary embodiments may provide a method for multiple analysis of a Raman spectroscopy signal which may be used to anticipate properties of an object to be measured in a non-destructive method using a Raman signal only.

Additional exemplary aspects and advantages will be set forth in part in the description which follows and, in part, will be apparent from the description, or may be learned by practice of the presented exemplary embodiments.

According to an aspect of an exemplary embodiment, a method for multiple analysis of a Raman spectroscopy signal includes repeating a process of obtaining a Raman signal with respect to a sample and a process of measuring a property with respect to the sample, with respect to a plurality of samples, extracting a plurality of parameters from the Raman signal obtained from each of the plurality of samples, and creating a multiple analysis algorithm such that a calculated property obtained by inputting the plurality of parameters obtained in the extracting of a plurality of parameters for each sample into the multiple analysis algorithm approximates the measured property, and in which a property of an object to be measured is anticipated by inputting a plurality of parameters extracted from a Raman signal with respect to the object to be measured into the learned multiple analysis algorithm.

Each of the plurality of samples and the object to be measured may include graphene, and the property may be at least one of a doping level, mobility, a degree of strain, a domain size, and a defect distance of the graphene.

The plurality of parameters extracted from the Raman signal may be at least two of intensities or intensity ratios, positions or positional ratios, widths at predetermined positions of a 2D peak, a G peak, and a D peak, and laser wavelength and intensity.

The plurality of parameters extracted from the Raman signal may include a plurality of parameters sequentially from a first one of an intensity of a 2D peak, an intensity of a G peak, an intensity ratio of the 2D peak and the G peak, a position of the 2D peak, a position of the G peak, a laser wavelength, a laser intensity, an intensity of a D peak, a position of the D peak, an intensity ratio between the 2D peak and the D peak, an intensity ratio between the G peak and the D peak, a positional ratio between the 2D peak and the G peak, a positional ratio between the 2D peak and the D peak, a positional ratio between the G peak and the D peak, widths of the 2D peak at a plurality of positions, widths of the G peak at a plurality of positions, and widths of the D peak at a plurality of positions.

The widths at a plurality of positions may be at least two of a 10% width, a 25% width, a 33% width, a 50% width (full width at half maximum), a 66% width, a 75% width, and a 90% width of a peak.

The multiple analysis algorithm may be an artificial neural network algorithm.

Each of the plurality of samples and the object to be measured may include a two-dimensional material.

The two-dimensional material may be at least one of graphene, MoS2, WS2, and WSe2.

According to one or more exemplary embodiments, since properties of an object to be measured may be anticipated in a non-destructive method using a Raman signal only, costs and time for mass production may be greatly reduced. Also, methods according to exemplary embodiments are non-destructive, and therefore provide high usability.

When the object to be measured is graphene, since a doping level, mobility, a degree of strain, a domain size, a defect distance, etc. of graphene, for example, may be obtained by measuring the Raman signal only by using the multiple analysis of a Raman spectroscopy signal, properties of the graphene may be obtained over a wafer during mass production.

### BRIEF DESCRIPTION OF THE DRAWINGS

These and/or other exemplary aspects and advantages will become apparent and more readily appreciated from the following description of exemplary embodiments, taken in conjunction with the accompanying drawings in which:

FIG. 1 is a Raman shift graph with respect to graphene and graphite;

FIG. 2 illustrates an example of properties related to a Raman signal of graphene;

FIG. 3 is a conceptual diagram of multiple analysis;

FIG. 4 is a conceptual diagram of a linear analysis as a comparative example;

FIG. 5 is a conceptual diagram of an artificial neural network algorithm embodying the multiple analysis of a Raman spectroscopy signal according to an exemplary embodiment; and

FIG. 6 is a flowchart for explaining a multiple analysis of a Raman spectroscopy signal according to an exemplary embodiment.

### DETAILED DESCRIPTION

Reference will now be made in detail to exemplary embodiments which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects of the present description. As used herein, expressions such as “at least one of,” when preceding a list of elements, modify the entire list of elements and do not modify the individual elements of the list.

Through multiple analysis of a Raman spectroscopy signal according to an exemplary embodiment, properties of an object to be measured, for example, a doping level, mobility, a degree of strain, a domain size, a defect distance, etc. may be determined. The object to be measured may be a two-dimensional material or a device, for example, an electronic device, which is obtained by stacking two-dimensional materials. The two-dimensional material may be at least one of graphene, molybdenum disulfide MoS2, tungsten disulfide WS2, and tungsten selenide WSe2. In the following description, although a method of anticipating properties of graphene in a non-destructive method through the multiple analysis of a Raman spectroscopy signal according to an exemplary embodiment is described, the present inventive concept is not limited thereto. The multiple analysis of a Raman spectroscopy signal according to an exemplary embodiment may be applied to anticipating necessary properties of any of various types of materials, in addition to graphene.

Each of parameters such as position, intensity, width, etc. of a peak obtained from a Raman signal of graphene shows a linear relationship with respect to properties of graphene in only one particular section. Thus, measuring the properties of graphene by a method of obtaining only a linear relationship with respect to a particular parameter obtained from a Raman signal of graphene may cause an error in the measurement of the properties of graphene. However, using a multiple analysis according to the present exemplary embodiment, numerous parameters, including a position, an intensity, and a width of a peak, and a wavelength and an intensity of laser, may be extracted from the Raman signal and may be simultaneously connected to properties of graphene, for example, a doping level, mobility, a degree of strain, a domain size, a defect distance, etc., thereby enabling the anticipation of desired properties with respect to an object to be measured using only the measurement of a Raman signal. The anticipation of properties may be performed by anticipating properties one by one or all properties at the same time through the multiple analysis of a Raman spectroscopy signal according to an exemplary embodiment.

The multiple analysis in the exemplary embodiment described herein is not a linear regression analysis, but corresponds to a type of non-linear regression analysis. For example, an artificial neural network algorithm may be used therefor.

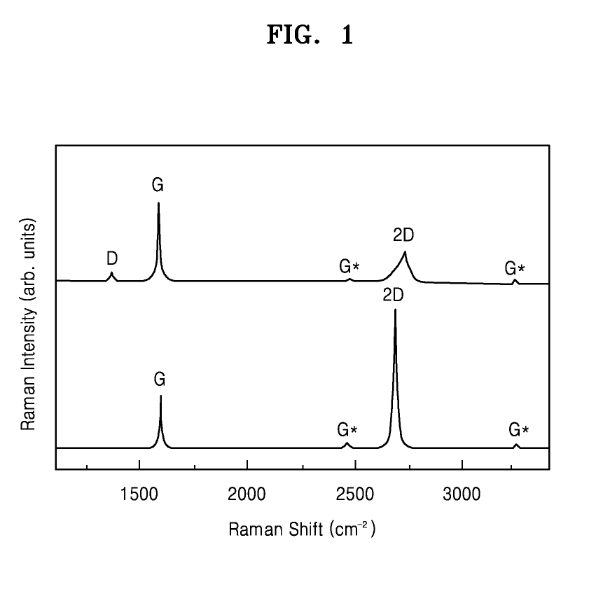

A Raman signal is obtained by emitting laser light and measuring changes in the intensity and wavelength of scattered light. A Raman shift graph obtained as above may have a very simple shape as illustrated in FIG. 1.

FIG. 1 is a Raman shift graph with respect to graphene and graphite.

Referring to FIG. 1, a Raman signal for graphene (the lower signal) shows a 2D peak, a G peak, and G* peaks, etc., whereas a Raman signal for graphite (the upper signal) shows the 2D peak, the G peak, a D peak, and the G* peaks.

The 2D peak and the G peak are basic peaks that occur for a material formed of carbon, for example, graphene or graphite. As illustrated in FIG. 1, for graphite, the size of the G peak appears to be relatively large and the size of the 2D peak appears to be relatively small with respect to the G peak. For graphene, the size of the 2D peak appears to be relatively large and the size of the G peak appears to be relatively small with respect to the 2D peak. Accordingly, as may be seen from the Raman shift graph of FIG. 1, the graphene and graphite may be distinguished by the relationship of the sizes of the G peak and the 2D peak thereof.

A D peak is generated when a defect occurs. For graphene, when a defect exists due to a graphene forming method, the D peak may be generated. For example, since transferred graphene, which has a good quality, hardly has any defects, the D peak may not be generated. In contrast, for the graphene that is formed by deposition, the possibility of having a defect is relatively high and thus the D peak may be generated.

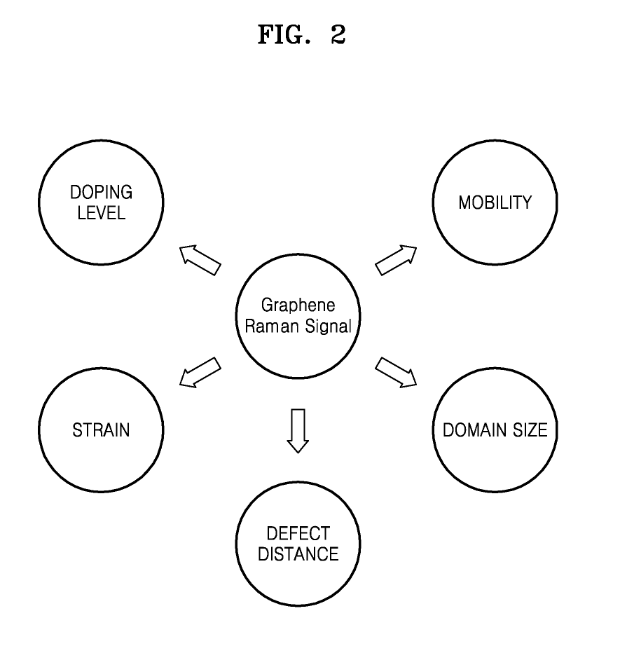

FIG. 2 illustrates an example of properties related to the Raman signal of graphene. A Raman signal measured with respect to graphene may have a very close relationship with respect to a doping level, mobility, a degree of strain, a domain (crystal) size, a defect distance, etc. of the graphene.

The properties, such as the doping level, mobility, degree of strain, domain (crystal) size, defect distance, etc., of the graphene may be obtained one by one or altogether at the same time through the method for multiple analysis of a Raman spectroscopy signal using a Raman signal according to an exemplary embodiment.

Accordingly, since these properties of graphene may be obtained in a non-destructive method over a wafer by using the method for multiple analysis of a Raman spectroscopy signal according to an exemplary embodiment, mass production of a device using graphene, for example, an electronic device using graphene, may be possible.

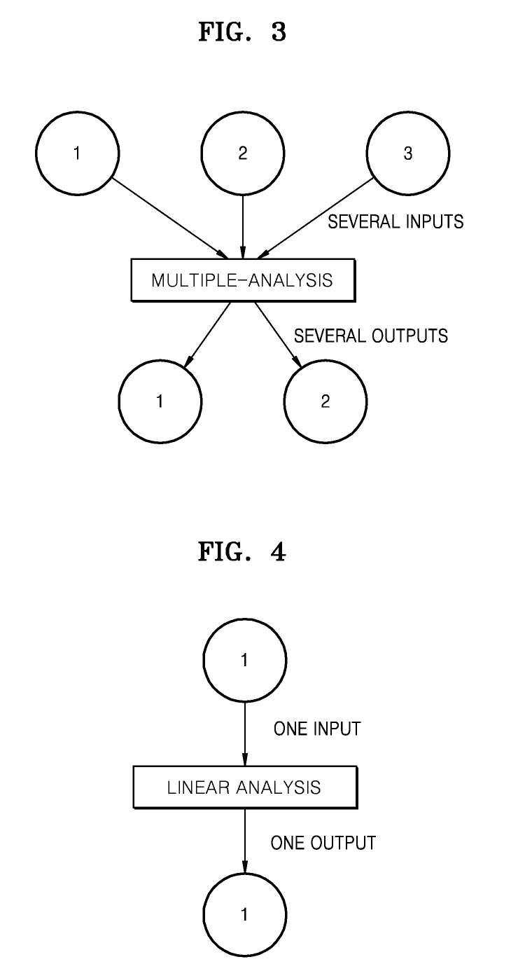

FIG. 3 is a conceptual diagram of multiple analysis. FIG. 4 is a conceptual diagram of a linear analysis as a comparative example.

As illustrated in FIG. 3, when multiple analysis is used, several inputs are multiple-analyzed and thus several outputs may be obtained. In contrast, as illustrated in FIG. 4, when a linear analysis is used, only one output is obtained for one input.

According to an existing method, there is one input and one output, and an interrelationship between the input and the output is obtained by a linear regression analysis. In contrast, according to a method for multiple analysis of a Raman spectroscopy signal according to an exemplary embodiment, as illustrated in FIG. 3, several inputs are input at once and several outputs, for example, at least two outputs, are output through a multiple analysis. An artificial neural network algorithm, for example, may be used as one of the multiple analysis method that enables the above operation. Also, it is possible to input several inputs and output outputs one by one.

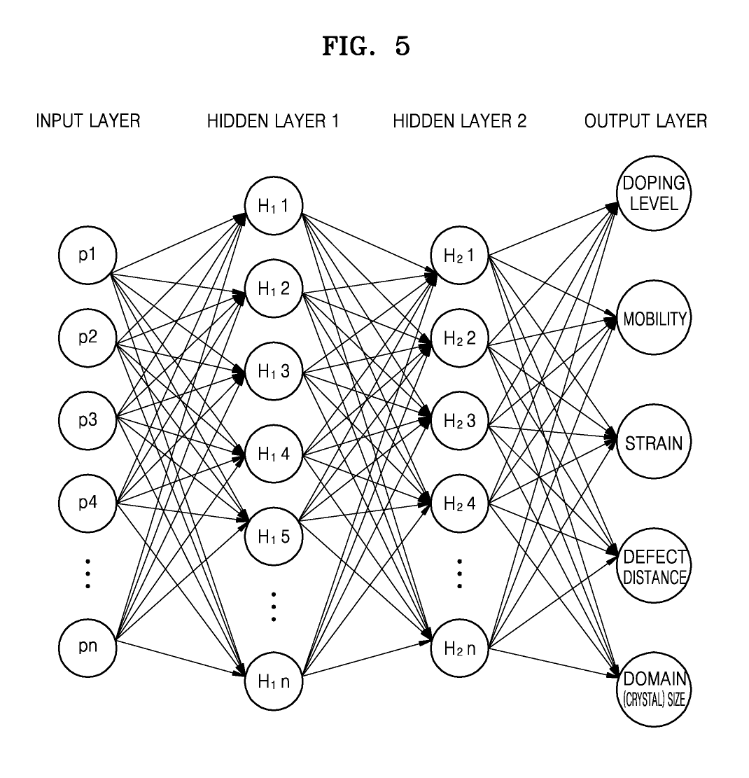

FIG. 5 is a conceptual diagram of an artificial neural network algorithm embodying multiple analysis of a Raman spectroscopy signal according to an exemplary embodiment.

Referring to FIG. 5, when many inputs p1, p2, . . . , pn are input to an input layer, a relational expression may be obtained so that many outputs, for example, a doping level, mobility, a degree of strain, a domain (crystal) size, a defect distance, etc., output from an output layer through a learning process in a plurality of hidden layers, for example, Hidden Layer 1 and Hidden Layer 2, may be obtained. Once a result is obtained through the learning process, an output with high reliability may be anticipated based on the next input. Although FIG. 5 illustrates a case of obtaining many outputs at the same time, the outputs may be obtained one by one for many inputs.

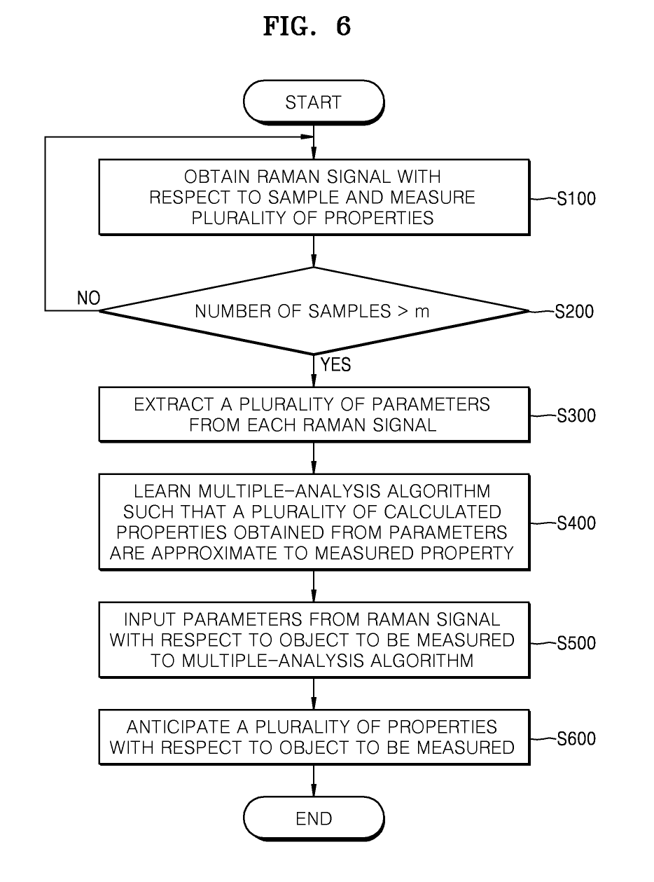

FIG. 6 is a flowchart for explaining a multiple analysis of a Raman spectroscopy signal according to an exemplary embodiment.

Referring to FIG. 6, first, a process of obtaining a Raman signal with respect to a sample and measuring necessary properties of the sample is repeated for a plurality of samples (S100). The process of obtaining a Raman signal of a sample and measuring necessary properties may be repeated until the number of samples reaches a desired number “m” (S200).

The number of samples may be a number that ensures reliability in the anticipation of properties obtained through a multiple analysis process according to an exemplary embodiment, for example, Raman signals may be obtained for 10 or more samples. Alternately, the number of samples may be about 100 or more to secure a greater reliability.

When the sample is a two-dimensional material such as graphene, or is a device including a two-dimensional material such as graphene, the determined property may be at least one of, for example, a doping level, mobility, a degree of strain, a domain size, a defect distance, etc.

Next, a plurality of parameters may be extracted from each Raman signal obtained from each of the samples (S300).

When the sample is a two-dimensional material such as graphene, or is a device including a two-dimensional material such as graphene, parameters extracted from the Raman signal may be at least two parameters selected from a group consisting of intensities or intensity ratios, positions or positional ratios, sizes of widths at predetermined positions of the 2D peak, the G peak, and the D peak, and laser wavelength and intensity.

For example, when the sample is a two-dimensional material such as graphene or is a device including a two-dimensional material such as graphene, parameters extracted from the Raman signal may include a plurality of parameters extracted sequentially, such as an intensity of the 2D peak, an intensity of the G peak, an intensity ratio of the 2D peak and the G peak, a position of the 2D peak, a position of the G peak, a laser wavelength, a laser intensity, an intensity of the D peak, a position of the D peak, an intensity ratio between the 2D peak and the D peak, an intensity ratio between the G peak and the D peak, a positional ratio between the 2D peak and the G peak, a positional ratio between the 2D peak and the D peak, a positional ratio between the G peak and the D peak, widths of the 2D peak at a plurality of positions, widths of the G peak at a plurality of positions, and widths of the D peak at a plurality of positions.

The widths at a plurality of positions may be at least two of a 10% width, a 25% width, a 33% width, a 50% width (full width at half maximum), a 66% width, a 75% width, and a 90% width of a peak.

For example, for the 2D peak, a 10% width, a 25% width, a 33% width, a 50% width (full width at half maximum), a 66% width, a 75% width, and a 90% width of the 2D peak may be extracted as the parameters.

For example, for the G peak, a 10% width, a 25% width, a 33% width, a 50% width (full width at half maximum), a 66% width, a 75% width, and a 90% width of the G peak may be extracted as the parameters. For example, for the D peak, a 10% width, a 25% width, a 33% width, a 50% width (full width at half maximum), a 66% width, a 75% width, and a 90% width of the D peak may be extracted as the parameters.

In addition to the above-described parameters, the parameters extracted from the Raman signal may include an ambient temperature, a thickness of a substrate, an intensity of another peak, a position of another peak, and widths of another peak at a plurality of positions. The another peak may be, for example, the G* peaks, and the widths of the another peak at a plurality of positions may be at least two of a 10% width, a 25% width, a 33% width, a 50% width (full width at half maximum), a 66% width, a 75% width, and a 90% width of the another peak.

After a plurality of parameters are extracted from a Raman signal obtained from each of the samples, it is learned through a multiple analysis algorithm, for example, an artificial neural network algorithm, such that a calculated factor value obtained by inputting the parameters into the multiple analysis algorithm for each sample may approximate the previously obtained measured property (S400).

As described above, in a state in which the learning is performed through the multiple analysis algorithm such as the artificial neural network algorithm, when a plurality of parameters are input, a relational expression, by which an output through the learning process may be close to a desired output, may be obtained.

Accordingly, once a result is obtained through learning, very reliable anticipation is available based only on the next input.

As such, in a state in which the multiple analysis algorithm, for example, an artificial neural network algorithm, is optimized through learning, when the above-described parameters are extracted from a Raman signal with respect to an object to be measured, and the extracted parameters are input to the learned multiple analysis algorithm (S500), an anticipated value of a property of the object to be measured may be obtained (S600). The anticipated value of the property may correspond to an actually measured value or may be close thereto. The properties may be extracted one by one or all desired properties may be extracted at one time, with a high reliability, through the learned multiple analysis algorithm, for example, an artificial neural network algorithm. The object to be measured may be formed of the same material as that of the samples. For example, the object to be measured may be graphene or a device including graphene. The parameters extracted from the Raman signal of the object to be measured may be the same parameters as those extracted from the Raman signal of the samples.

In other words, the same parameters as those extracted from the Raman signal with respect to a plurality of samples used for determining the learned multiple analysis algorithm, for example, artificial neural network algorithm are extracted from the Raman signal of the object to be measured, and may be input into the learned multiple analysis algorithm for example, the artificial neural network algorithm.

Accordingly, when the object to be measured is graphene, the anticipated properties such as a doping level, mobility, a degree of strain, a domain size, a defect distance, etc. may be output through the learned multiple analysis algorithm, for example, artificial neural network algorithm.

FIGS. 5 and 6 illustrate a case in which the multiple analysis algorithm is configured to output the anticipated values of the properties all at once. However, this is not limiting, and the multiple analysis algorithm may be configured to output the desired properties of the object to be measured one by one.

A method of multiple analysis of a Raman spectroscopy signal according to an exemplary embodiment described herein may be a computer-implemented method performed by a processor, and may be embodied as instructions, stored on a non-transitory computer-readable medium, which, when executed on a processor, perform the above-described exemplary method.

According to a method of multiple analysis of a Raman spectroscopy signal according to an exemplary embodiment, since a doping level, mobility, a degree of strain, a domain size, a defect distance, etc. of graphene may be obtained by measuring the Raman signal only, costs and time for mass production may be greatly reduced. Also, since the above-described method is a non-destructive method, usability of the method is very high.

In the above description, although an example is described in which the sample and the object to be measured are graphene or a device including graphene, the material to be analyzed is not limited to graphene. The method for multiple analysis of a Raman spectroscopy signal according to an exemplary embodiment may be applied to any of different types of two-dimensional materials or other types of materials that may be measured using a Raman signal.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present inventive concept have been described with reference to the figures, it will be understood by those of ordinary skill in the art that various changes in form and details may be made therein without departing from the spirit and scope of the present inventive concept as defined by the following claims.

What is claimed is:

1. A method for multiple analysis of a Raman spectroscopy signal, the method comprising:
obtaining a Raman signal with respect to a sample;
measuring a property of the sample, thereby obtaining a measured property;
extracting a plurality of parameters from the Raman signal;
repeating the obtaining, the measuring and the extracting for each of a plurality of samples;
creating a multiple analysis algorithm, using the property and the plurality of parameters of each of the plurality of signals, such that a calculated property, obtained by inputting the plurality of parameters into the multiple analysis algorithm is approximate to the measured property for each of the plurality of samples;
obtaining an anticipated property of an object to be measured based on a plurality of parameter extracted from a Raman signal with respect to the object to be measured and the multiple analysis algorithm.

2. The method of claim 1, wherein each of the plurality of samples and the object to be measured comprises graphene, and the anticipated property is at least one property selected from a group consisting of a doping level of the graphene, a mobility of the graphene, a degree of strain of the graphene, a domain size of the graphene, and a defect distance of the graphene.

3. The method of claim 2, wherein the plurality of parameters comprise at least two parameters selected from a group consisting of an intensity of a 2D peak, an intensity of a G peak, an intensity of a D peak, an intensity ratio of two of the 2D peak, the G peak, and the D peak, a position of the 2D peak, a position of the G peak, a position of the D peak, a positional ratio of two of the 2D peak, the G peak, and the D peak, a widths of the 2D peak at predetermined positions, widths of the G peak at predetermined positions, widths of the D peak at predetermined positions, a laser wavelength, and a laser intensity.

4. The method of claim 1, wherein the plurality of parameters comprise at least two parameters selected from a group consisting of an intensity of a 2D peak, an intensity of a G peak, an intensity of a D peak, an intensity ratio of two of the 2D peak, the G peak, and the D peak, a position of the 2D peak, a position of the G peak, a position of the D peak, a positional ratio of two of the 2D peak, the G peak, and the D peak, a widths of the 2D peak at predetermined positions, widths of the G peak at predetermined positions, widths of the D peak at predetermined positions, a laser wavelength, and a laser intensity.

5. The method of claim 3, wherein the extracting the plurality of parameters comprises extracting the plurality of parameters, one at a time, sequentially.

6. The method of claim 5, wherein the widths of each of the 2D peak, the G peak, and the D peak comprise at least two of a 10% width, a 25% width, a 33% width, a 50% width, a 66% width, a 75% width, and a 90% width of a peak.

7. The method of claim 5, wherein the multiple analysis algorithm is an artificial neural network algorithm.

8. The method of claim 7, wherein each of the plurality of samples and the object to be measured comprises a two-dimensional material.

9. The method of claim 8, wherein the two-dimensional material is at least one of graphene, MoS2, WS2, and WSe2.

10. The method of claim 5, wherein each of the plurality of samples and the object to be measured comprises a two-dimensional material.

11. The method of claim 10, wherein the two-dimensional material is at least one of graphene, MoS2, WS2, and WSe2.

12. The method of claim 4, wherein the extracting the plurality of parameters comprises extracting the plurality of parameters, one at a time, sequentially.

13. The method of claim 12, wherein the widths of each of the 2D peak, the G peak, and the D peak comprise at least two of a 10% width, a 25% width, a 33% width, a 50% width (full width at half maximum), a 66% width, a 75% width, and a 90% width of a peak.

14. The method of claim 12, wherein the multiple analysis algorithm is an artificial neural network algorithm.

15. The method of claim 12, wherein each of the plurality of samples and the object to be measured comprises a two-dimensional material.

16. The method of claim 15, wherein the two-dimensional material is at least one of graphene, MoS2, WS2, and WSe2.

17. The method of claim 1, wherein the multiple analysis algorithm is an artificial neural network algorithm.

18. The method of claim 1, wherein each of the plurality of samples and the object to be measured comprises a two-dimensional material.

19. The method of claim 18, wherein the two-dimensional material is at least one of graphene, MoS2, WS2, and WSe2.

20. A non-transitory computer-readable medium for multiple analysis of a Raman spectroscopy signal, comprising instructions stored thereon, that when executed on a processor, perform:
obtaining a Raman signal with respect to a sample;
measuring a property of the sample, thereby obtaining a measured property;
extracting a plurality of parameters from the Raman signal;
repeating the obtaining, the measuring and the extracting for each of a plurality of samples;
creating a multiple analysis algorithm, using the property and the plurality of parameters of each of the plurality of signals, such that a calculated property, obtained by inputting the plurality of parameters into the multiple analysis algorithm is approximate to the measured property for each of the plurality of samples;
obtaining an anticipated property of an object to be measured based on a plurality of parameter extracted from a Raman signal with respect to the object to be measured and the learned multiple analysis algorithm.
